(19) United States
(12) Patent Application Publication
(10) Pub. No.: US 2020/0159624 A1
(43) Pub. Date: May 21, 2020

(54) System, Method and Process for Protecting Data Backup from Cyberattack

(71) Applicant: Cloud Daddy, Inc., Middletown, NJ (US)

(72) Inventors: Konstantin Malkov, Holmdel, NJ (US); Joseph Merces, Middletown, NJ (US); Dmitry Tunitsky, Moscow (RU)

(73) Assignee: Cloud Daddy, Inc., Middletown, NJ (US)

(21) Appl. No.: 16/451,497

(22) Filed: Jun. 25, 2019

Related U.S. Application Data
(60) Provisional application No. 62/662,491, filed on Apr. 25, 2018.

(51) Int. Cl. G06F 11/14; G06F 11/34; G06F 9/455; G06N 20/00

(52) U.S. Cl. CPC G06F 11/1448; G06F 11/3476; G06F 11/1469; G06F 2009/45587; G06N 20/00; G06F 2009/45575; G06F 9/45533

(57) ABSTRACT

System, method and process for securing and protecting data and data backups from cyberattack and implementing disaster recovery using machine learning and artificial intelligence. Embodiments learn and establish baseline parameters of routine, normal and non-compromised behavior and activity of virtual machines operative in cloud ecosystem, detect and recognize anomalous events related to advanced persistent threats to the instance, such as ransomware, and automatically implement preconfigured actions as determined by a user with the primary objective of protecting data and data backups.

### CROSS-REFERENCES TO RELATED APPLICATIONS

This application is the Non-Provisional Application of Provisional Application No. 62/662,491 (Confirmation No. 6989) filed on Apr. 25, 2018 for “Artificial Intelligence (AI) triggering Backup and Disaster Recovery and other security measures to protect from Cyberattacks (Security and Backup as Services)” by Joseph Merces, et al. This Non-Provisional Application claims priority to and the benefit of that Provisional Application, the contents and subject of which are incorporated herein by reference in their entirety, including all references cited and incorporated within the Provisional Application.

### STATEMENT REGARDING FEDERALLY SPONSORED RESEARCH OR DEVELOPMENT

Not Applicable

### BRIEF DESCRIPTION OF THE INVENTION

Embodiments of the invention are directed towards systems, methods and processes for securing and protecting data and data backups from cyberattack and implementing disaster recovery all using machine learning and artificial intelligence (“AI”) technology. Embodiments learn and establish baseline parameters of routine, normal and non-compromised behavior and activity of virtual machines operative in cloud ecosystem, detect and recognize anomalous events related to advanced persistent threats to the instance, such as ransomware, and automatically implement preconfigured actions as determined by a user with the primary objective of protecting data and data backups.

### BACKGROUND

Traditionally, datacenter server backups are manually scheduled to occur at specific configured times during the day and/or evening hours or manually on demand. With the advent of Internet based cloud services and virtual machines (“VMs”), backups of servers and the data they house are generally still manually scheduled to occur at preconfigured times during the day/evening hours or manually. In today's world of increasing cybersecurity threats such as ransomware, not only are the servers, VMs and data at risk, but even the data backups are in jeopardy of infection, and worse, being encrypted and held for ransom or even destroyed. There are countless examples of organizations—occurring with greater frequency—within the public and private sectors worldwide that have had the very backups they rely on to recover from when disaster strikes either encrypted or totally erased in order to force ransom payment. Destruction, eradication or ransom of data backups inflicts incalculable harm. Government agencies, large enterprises, and small and medium size business are growing as prospective targets. The recent ransomware attacks on the U.S. cities of Baltimore, Md. and Atlanta, Ga., among others, are prime examples.

The prior art of legacy/traditional data backups fail to conduct real time monitoring and protection from threats to data backups. Moreover, since most data back-ups are “simple backups,” wherein the backup service merely provides file and folder level backups and restores, the backed-up data may be compromised at any time by an “advanced persistent threat” (“APT”), such as, but not limited to, ransomware. To complicate matters, data backup software products are now being marketed and sold as “data protection.” “Data backup” is not the same as “data protection.” This has created confusion in the market place on the part of organizations thinking that their so called “data protection” software will be able to restore critical systems after a ransomware attack, only to find that not only did the ransomware encrypt their servers, VMs and systems, but it also ruined their ability to recover from their data backups, and even destroyed the very data protection software used to create their backups. The recent ransomware attacks conducted against the City of Atlanta, Ga., the Erie County Medical Center in NY and the City of Baltimore, Md., among others, are prime examples. Labeling a “backup” product as data “protection” may have worked years ago, but in today's cyberattack riddled world, this description no longer works or fits for most backup products that continue to refer to themselves as “data protection.” When organizations attempt to recover following a ransomware attack and discover that the very backups they were relying upon to restore their systems have also been compromised and their backup software has been destroyed, many questions get directed at their “data protection” product representatives.

What is therefore needed for all cloud computing systems and operations, including public, private and government based data centers, is true “data protection”—a transformative system, method and/or process that incorporates real time cybersecurity countermeasures along with true data backup protection, since the backup is generally the last line of defense for an organization, particularly when an organization's cloud or private network system is under attack from an APT such as ransomware. Embodiments of the invention meet that need by utilizing machine learning and AI to establish baseline parameters of routine, normal and non-compromised machine behavior, recognizing anomalous events related to APTs, such as ransomware, and implementing a host of actions with the primary objective of protecting data backups wherever the backups exist. Embodiments of the invention operate or are otherwise implemented within a VM platform residing within a highly secure virtual cloud environment, such as that contained within, for example, Amazon Web Services (AWS), Microsoft Azure, Google Cloud or any such other public and private cloud environments.

While it is generally recognized that the AWS cloud is more secure in comparison to on-premises hosted environments and that government agencies can certainly reap the benefits of the Federal Risk and Authorization Management Program (FEDRAMP) certified AWS GovCloud, embodiments of the invention may be implemented in any number of cloud-based platforms. While the cyber-hacking community and nation state actors have remained focused on infiltrating local on-premises hosted data centers, such as those generally found with government agencies, migration to the public cloud continues to gain momentum. Cloud-based platforms and ecosystems will therefore increase as potential targets of infiltration and destruction for an APT like ransomware. While embodiments of the invention may be implemented to providing data backup protection within any public or private datacenter, embodiments are particularly suited for cloud-based systems, platforms and ecosystems such as AWS, Microsoft Azure, Google Cloud, or any other public and private cloud environments.

### SUMMARY OF THE INVENTION

Embodiments of the invention are directed towards systems and methods for securing and protecting cloud-based data and data backups and implementing disaster recovery from cyberattack using machine learning and AI technology.

In embodiments, machine learning and AI (as used herein, AI comprises the various machine learning of embodiments, including statistical and vector algorithms, and deep learning, as well as anomaly detection) are utilized to continuously and in real time analyze the system and event logs of a VM and the host machine on which it operates, in addition to online data streams as may be available from or provided by the cloud ecosystem platform, to establish various baselines indicative of normal, routine and non-compromised (typical) operations, activity and behavior. Through machine learning, embodiments of the invention establish various baseline(s) in terms of normal machine behavior and through the incorporation of machine learning and AI logic, are able to detect through interpretation and analysis anomalous events related to APTs (e.g., ransomware) and take remedial action with a primary directive of protecting data backups. In particular, and as further disclosed herein, system logs and online data streams of various operating resources such as the host's or VM's CPU activity, memory, disk usage (read/write/etc.), network and bandwidth activity are closely monitored and analyzed to establish baselines that fall within normal or typical operating parameters. When within the virtual public cloud of the AWS ecosystem, for example, system logs may also include VPC flow logs, DNS logs, CPU, memory, disk activity, network traffic, as well as CloudTrail event log analysis. Through machine learning, embodiments continually learn from the monitored resources as to what constitutes normal, routine and non-compromised (typical) activity and what constitutes anomalous (atypical) activity indicative of a threat to the VM. Through machine learning and AI, patterns of behavior and activity are continually accessed, processed and monitored. Embodiments of the invention continue with such real time monitoring of system logs and online data streams, and when one or more such monitored operating parameters deviates from its established baseline for normal, non-compromised activity—thereby signifying an anomaly and detecting a potential threat to the data and operating resources of the VM and host machine—embodiments of the invention may initiate various predetermined, specific automatic actions in response thereto, including specific automatic actions from the standpoint of backup and disaster recovery protection.

When anomalies and threat events are detected by embodiments of the invention, various pre-determined actions (as determined by users thereof or by the machine learning/AI module thereof) may be automatically initiated. Primary objectives of embodiments of the invention are directed towards protecting data backups and replications that have been previously performed, catalogued, and stored in various networked locations as described herein. Such “actionable automation” includes configurable feature capabilities such as: 1) alerting, such as, for example, alerting authorized, pre-determined (designated) users of the invention or any such other individuals in the form of Simple Notification Service (“SNS”), email, voice call and text message, 2) backup, such as, for example, system and data backup to other regions (such as, for example, another Cloud Region under the AWS cloud computing platform, discussed below) or to other accounts by the user (such as, for example, other AWS cloud computing accounts, discussed below), 3) quarantine, such as, for example, quarantine and catalogue prior backup(s) and replications performed by embodiments of the invention regardless of cloud cross-region and cross-account stored, quarantine a specific machine exhibiting anomalous behavior, etc., 4) restore, such as, for example, restoring a last known good (non-compromised) backup of a machine, selection and restoration from an older archived or quarantined backup or replication, 5) replication, such as, replication of previously created data backups, such as, for example, creation of an Amazon Machine Image or “AMI” and snapshots of data backups to other regions of the cloud ecosystem, such as data centers, replication to other accounts (e.g., cloud-based accounts containing different login credentials and passwords within different data centers for added security and access), and 6) shutdown, such as, for example, shutting down network connectivity to a machine exhibiting anomalous behavior, shutting down one or more ports to a machine, shutting down the machine, and in conjunction with any of the above, running various cybersecurity countermeasures as well as invoking a multitude of other actions, including copying or replicating VMs to an entirely different private cloud or public cloud service, such as, for example, Microsoft Azure, Google Cloud, etc., all for the objective of protecting enterprise backups and disaster recovery from cybersecurity compromise.

Embodiments of the invention utilize one or more constructive algorithms within various steps for processing and identifying events (both routine (typical) and anomalous (atypical) events) registered in system logs of VMs (a specific VM running within a server is also referred to herein as an “instance”—a term commonly utilized in the industry to refer to each such VM operating on a host digital processor or machine under the supervision of a hypervisor software module, such as, for example, Hyper-V® by Microsoft Corporation, Redmond, Wash., or VMWare ESXi byVMware, Inc., Palo Alto, Calif., or any other hypervisor software modules or systems that allow for the creation of one or more VMs on a host machine). Ideologically, such process algorithms are generally based on a combination of three well-known approaches: fuzzy sets theory (the fact that the event is “typical” or “atypical” is determined by the value of its membership degree), the method of potential functions (the metric properties of events are determined with the help of a nonnegative symmetric kernel of one or another form), and deep learning algorithms. From a theoretical point of view, it is an adaptive learning process algorithm that allows for identification of evaluated events. From a practical point of view, it is also a process algorithm that provides the opportunity to simultaneously estimate the degree of “typicality,” calculate 3D coordinates, and provide computer visualization of these events. (The visualization is provided for human analysis, such as that after an attack, and performing additional remediation of a cyberattack to better understand the anomalous behaviors detected and acted upon through any of the preconfigured actions and directives.)

As used herein, the term “host digital machine” or “host machine” refers to the actual physical machine upon which one or more VMs or instances may operate. The host machine is generally comprised of a digital processor or CPU that may have some associated volatile memory, generally in the form of RAM, a digital storage device generally in the form of one or more hard disk drives (including, but not limited to, solid state drives, or any such other storage devices that may evolve within the technology) that may serve as the main digital memory associated with the digital processor and where files and other associated data are generally stored, a network communications device, such as a network interface controller (NIC) or device, and other hardware commonly known and understood and upon which one or more operating systems and various software platforms or layers operate to comprise the entire host machine and upon which one or more VMs operate. The digital processor of the host machine is referred to herein as the host processor or host digital processor. Further, as used herein, the terms “digital memory,” “disk memory” and “memory” are used interchangeably and are generally intended as meaning the memory capability of the host disk drive(s), although without departing from the spirit and scope of the embodiments, additional forms of memory may be encompassed. It is also to be understood that host machines may employ multiple digital processors, digital storage devices, memory devices, etc. in various configurations commonly known.

As used herein, the term “instance” refers to a virtual machine or virtual server instance running on a cloud-based platform in a public or private cloud network. In the case of the virtualized cloud-based web hosting services offered by Amazon Web Services, Inc., a subsidiary of Amazon.com, Inc., Bellevue, Wash. (collectively, “Amazon”), also known as AWS (and the various permutations of the services offered by Amazon under AWS), an “EC2 instance” is a virtual server in Amazon's Elastic Compute Cloud (“EC2”) for running applications on the AWS infrastructure. AWS is a comprehensive, evolving cloud computing platform; EC2 is a service that allows business subscribers to run application programs in the computing environment. EC2 can serve as a practically unlimited set of VMs or EC2 instances. Users of AWS's EC2 services have at their disposal a virtual cluster of computers, available all the time through the Internet. The AWS EC2 platform of virtual computers, discussed in greater detail herein, emulates most of the attributes of a real computer including hardware (CPU(s) and GPU(s) for processing, local/RAM memory, hard-disk/SSD storage); a choice of operating systems; networking; and pre-loaded application software such as web servers, databases, CRM, etc. As used herein, the term “instance” also comprises an AWS EC2 instance.

As used herein, “AWS” shall generally refer to the virtual cloud computing platform services offered by Amazon, including Amazon's EC2 virtual servers (VMs or instances).

As used herein, “ransomware” shall generally refer to any type of malware that prevents or limits users from accessing their system, machine or instance, the data comprising same, and/or any backups of the instance and/or data of same, unless a ransom is paid. More modern ransomware families, collectively categorized as crypto ransomware, encrypt certain file types on infected systems, machines and instances and force users to pay the ransom through certain online payment methods to get a decrypt key. However, it is to be understood as used herein the term “ransomware” is also meant to comprise any type of malicious software or attack that presents a potential threat to the security and/or integrity of data backups.

### BRIEF DESCRIPTION OF THE DRAWINGS

FIG. 1 is a schematic layout of a virtualized information technology environment in which multiple VMs (instances), each with an embodiment of the invention operative therein (referenced as System 100), are operative on a single digital physical host machine.

FIG. 2 is a functional block diagram illustrating an operative embodiment of the invention (referenced as System 100) within a virtual cloud hosting environment, such as, for example, that provided by AWS.

FIG. 2A is a schematic layout of two VMs 60, each comprising an embodiment of the invention (referenced as System 100) wherein each instance is operative in separate AWS availability zones and wherein each instance comprises a public subnet and a private subnet, all within an AWS virtual cloud computing platform.

FIG. 2B is a schematic layout of two VMs 60 operative on a host machine 80 and the relation thereof to various data backup systems available through the AWS cloud platform.

FIG. 3 is a flow diagram of an embodiment of the invention depicting artificial intelligence module 300, further comprising machine learning logic module 200 and AI anomaly detection engine 300A, and actionable logic module 400. It is to be expressly understood that such features, elements and modules of embodiments are inter-related (as shown by the arrows in both directions in FIG. 3), run continuously when System 100 is launched and operative, and operate concurrently and in real time to establish baselines and monitor for and detect anomalous events that require initiation of actionable logic directives 400 directed towards protecting data backups and replications.

FIG. 4 is an alternative perspective flow diagram and schematic layout of an embodiment of the invention depicting artificial intelligence module 300, further comprising machine learning logic module 200 and AI anomaly detection engine 300A, and actionable logic module 400. It is to be expressly understood that such features, elements and modules of embodiments are inter-related, run continuously when System 100 is launched and operative, and operate concurrently and in real time to establish baselines and monitor for and detect anomalous events that require initiation of actionable logic directives 400 directed towards protecting data backups and replications.

FIG. 5 is a flow diagram of an embodiment illustrating learning stage process steps of machine learning module 200 and classification stage process steps of AI anomaly detection engine 300A of artificial intelligence module 300.

### FIGURE REFERENCES

These and other more detailed objects of the present invention will be disclosed when taken in conjunction with the following Detailed Description of the Invention in which like numerals represent like elements. The following is a listing of the reference numbers and the associated elements and features of embodiments as shown in the attached drawings:

### COMPONENTS/ELEMENTS/FEATURES REFERENCE NUMBERS

00 AWS cloud
02 Digital communication network (internet)
04 AWS internet gateway
06 Router
10 AWS Cloud Region
12 AWS virtual private network (VPC)
14 AWS Subnet
   14A Public AWS subnets
   14B Private AWS subnets
   14A-1 Public AWS subnet of an instance 60 in Availability Zone 1
   14A-2 Public AWS subnet of an instance 60 in Availability Zone 2
   14B-1 Private AWS subnet of an instance 60 in Availability Zone 1
   14B-2 Private AWS subnet of an instance 60 in Availability Zone 2
16 AWS Security Group
20 Remote management platform console/dashboard for System 100
22 HTTPS functional network connection between System 100 and remote management console 20
24 AWS EBS data backup storage system
26 AWS EFS data backup storage system
28 AWS instance storage system
30 AWS S3 data backup storage system
32 Bucket of snapshots 34, e.g., AMIs, in AWS S3 data backup storage system 30
34 Snapshots 34, e.g., AMIs, in AWS S3 data backup storage system 30
40 Data backup (instance) memory/disk storage device
60 VM or instance operative on a host machine 80 in a virtual computing cloud-based platform or environment 00, such as, for example, the AWS cloud computing platform.
62 Virtual disk/memory
64 VM operating system (OS)
66 VM software/resources/applications
80 Host machine operative in a virtual computing cloud-based platform or environment 00, such as, for example, AWS, in which one or more VMs or instances 60 operate.
82 Hardware portion
84 Memory/disk
86 CPU/microprocessor
88 Software portion (comprising VMs/instances operative thereon)
89 Hypervisor module
100 An operative system/process embodiment of the invention generally designated herein for illustrative purposes as “System.”
112 Interface/interaction between machine learning logic element/feature/process/module 200 and AI engine element/feature/process/module 300 of System 100
122 Interface/interaction between and AI engine element/feature/process/module 300 and actionable logic element/feature/process/module 400 of System 100
200 Machine learning logic element/feature/process/module of artificial intelligence element/feature/process/module 300 of System 100
210 Access machine data step
220 Primary feature mapping step
230 Secondary feature mapping step
240 Clusterization step
250 Detection of cluster centers step
260 Data reduction step
270 Detection of scaling coefficients step
280 Construction of projections of quantized events step
300 Artificial intelligence element/feature/process/module of System 100, comprising inter-related machine learning logic process 200 and AI anomaly detection engine process 300A
300A AI anomaly detection engine of module 300
310 Quantizing input entries step
320 Clusterization of quantized events step
330 Visualization of quantized events step
400 Actionable logic element/feature/process/module of System 100
460 Various exemplary action items that may preconfigured by users

The within description and illustrations of various embodiments of the invention are neither intended nor should be construed as being representative of the full extent and scope of the present invention. While particular embodiments of the invention are illustrated and described, singly and in combination, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited in any fashion. Rather, particular, detailed and exemplary embodiments are presented.

The images in the drawings are simplified for illustrative purposes and are not necessarily depicted to scale. To facilitate understanding, identical reference numerals are used, where possible, to designate substantially identical elements that are common to the figures, except that suffixes may be added, when appropriate, to differentiate such elements.

Although the invention herein has been described with reference to particular illustrative and exemplary physical embodiments thereof, as well as a methodology thereof, it is to be understood that the disclosed embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

### DETAILED DESCRIPTION OF THE INVENTION

A more detailed description of the invention now follows.

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of the more general classes. In general, use of any specific exemplar is intended to be representative of its class, and the non-inclusion of specific components (e.g., operations), devices, and objects should not be taken as limiting.

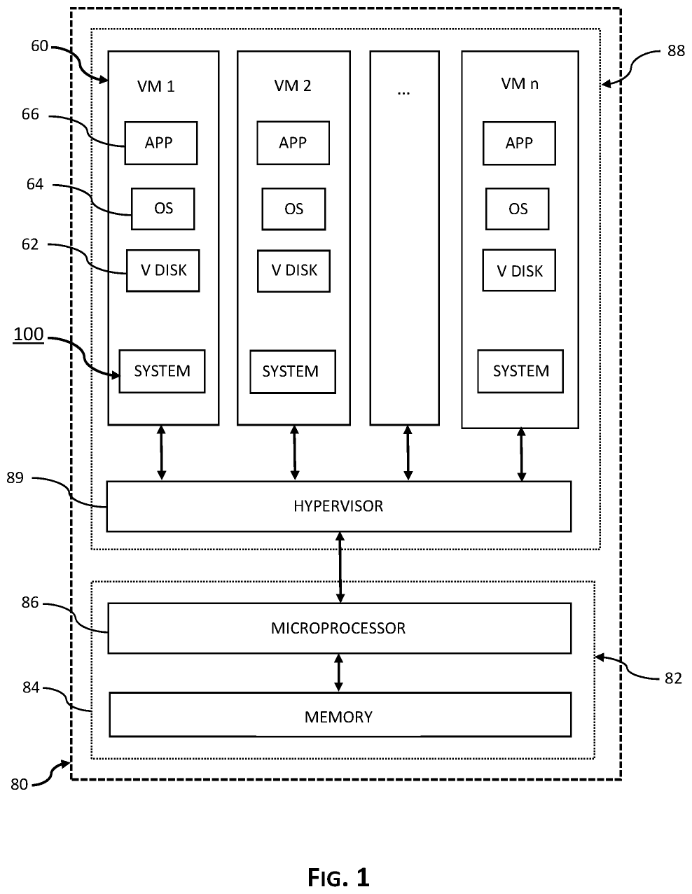

FIG. 1 is a schematic layout of a virtualized information technology environment in which multiple virtual digital processing machines, each with an embodiment of the invention operative therein (referenced as System 100), are operative on a single digital physical host machine.

The host machine 80 of FIG. 1 may be viewed as comprising two distinct layers: a hardware layer 82 and a software layer 88 operative on the hardware layer. VMs (instances) 60 are depicted as operating with the software layer 88.

The hardware layer 82 may, for instance, be the physical components such as, but not limited to, a digital host processor or CPU 86 and an associated digital memory storage device 84, such as, for example, a digital hard disk drive (including, without limitation, solid state drives). These may, for instance, be any of the well-known digital computing processors and digital electronic memory/storage devices that are commercially available.

The software layer 88 may be an implementation of a virtual computing environment in which a hypervisor software module 89 may implement one or more instances or VMs 60. Each instance 60 may be further comprised of a guest operating system 64 that may be associated with a virtual digital memory (virtual disk) 62 and may run one or more guest software applications 66. The instances/VMs 60 of FIG. 1 further comprise embodiments of System 100 operative therein and as detailed further below.

Each instance 60 may appear to an end user to be functionally equivalent to a physical digital machine, allowing applications such as, but not limited to, word processors, spreadsheets and databases or other software applications and platforms, or some combination thereof, to be used. Each VM 60 may operate its own and separate operating system (OS) such as, but not limited to, Microsoft Windows®, Apple OS or Linux open source operating system, all of which may run or operate as a guest operating system 64 on the VM 60.

Translating the instructions issued by the guest software programs or applications 66 operating on each VM 60 into actions that can be performed by the digital host processor 86 may be accomplished by a hypervisor software module 89. The hypervisor software module 89 may, for instance, be one of the well-known virtualization platforms such as, but not limited to, one of the Hyper-V® family of software platforms provided by the Microsoft Corporation of Redmond, Wash., or VMWare ESXi byVMware, Inc., Palo Alto, Calif. (or such any other hypervisor software modules or systems that allow for the creation of one or more VMs on a host machine). While the Hyper-V® family of hypervisor platforms and ESXi byVMware are considered herein as examples, it is expressly understood that the disclosed embodiments of the invention are not in any way limited to that specific hypervisor module.

The hypervisor software module 89 may, for instance, translate requests by a VM 60 to access its virtual digital memory (virtual disk) 62 into a request to access to the physical, digital memory storage device 84 associated with the host processor 86.

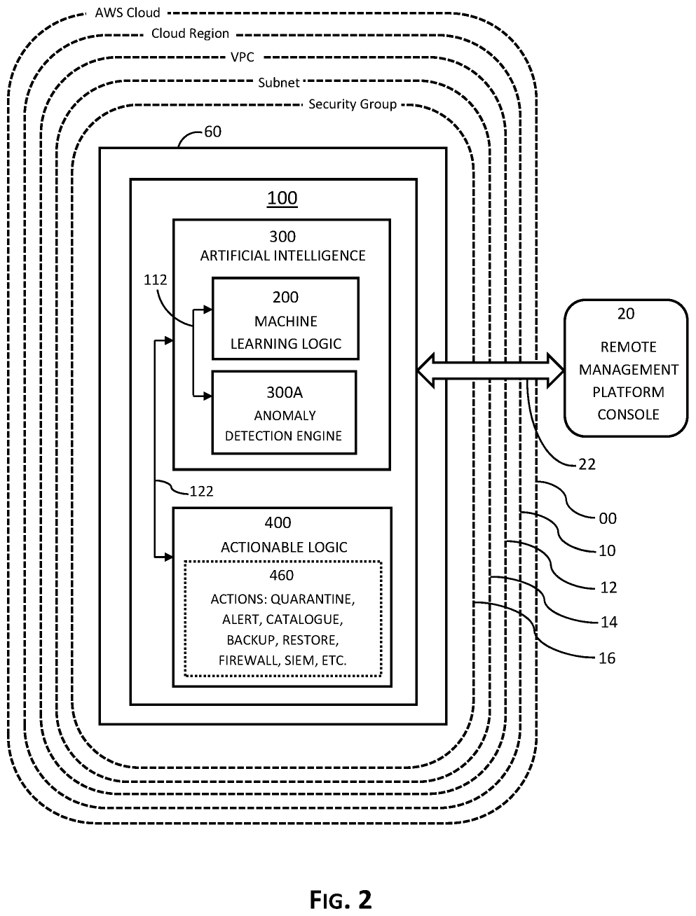

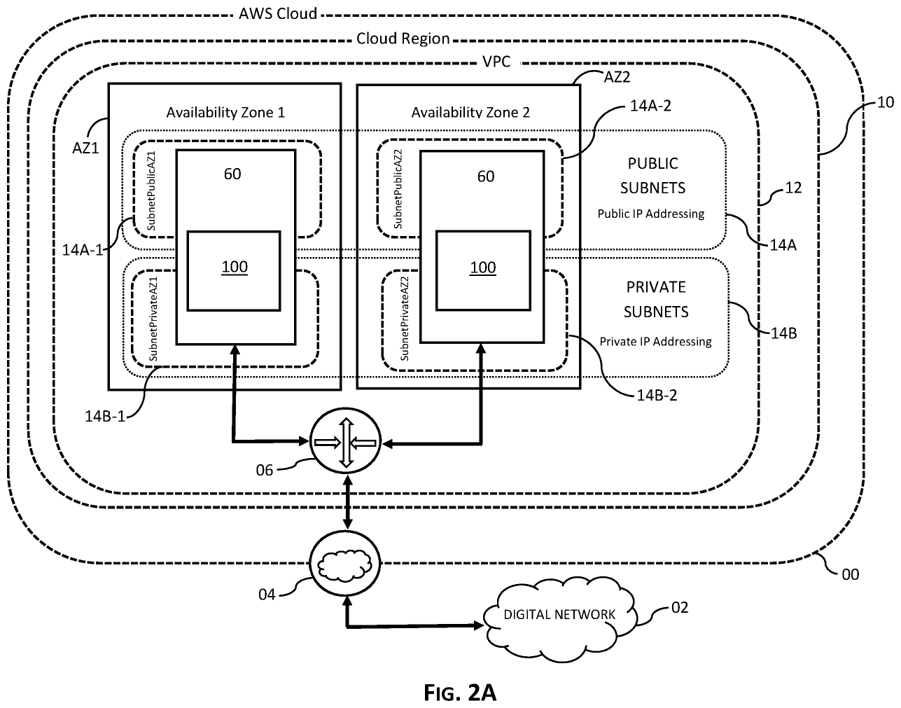

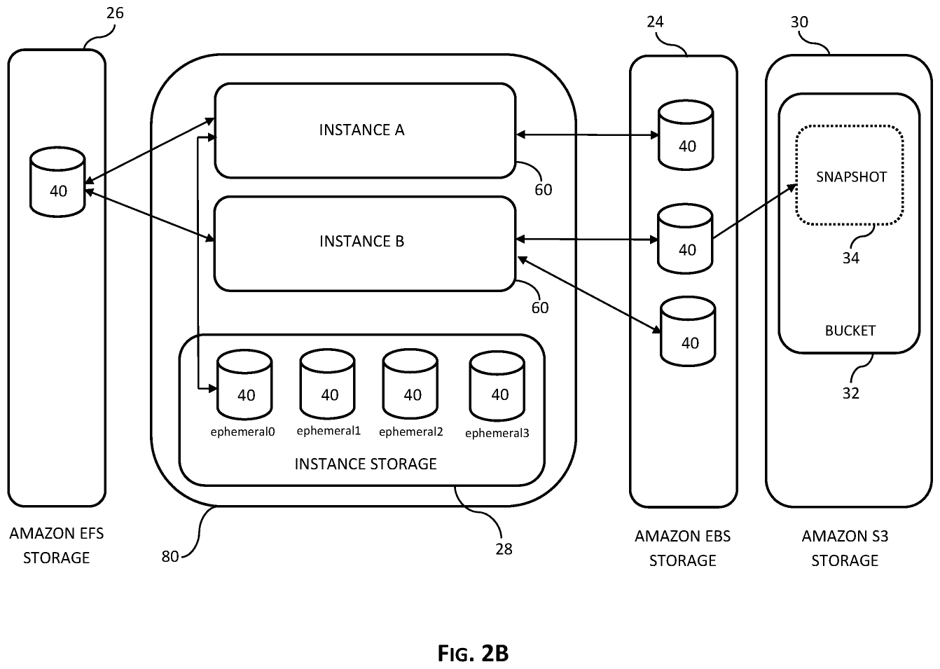

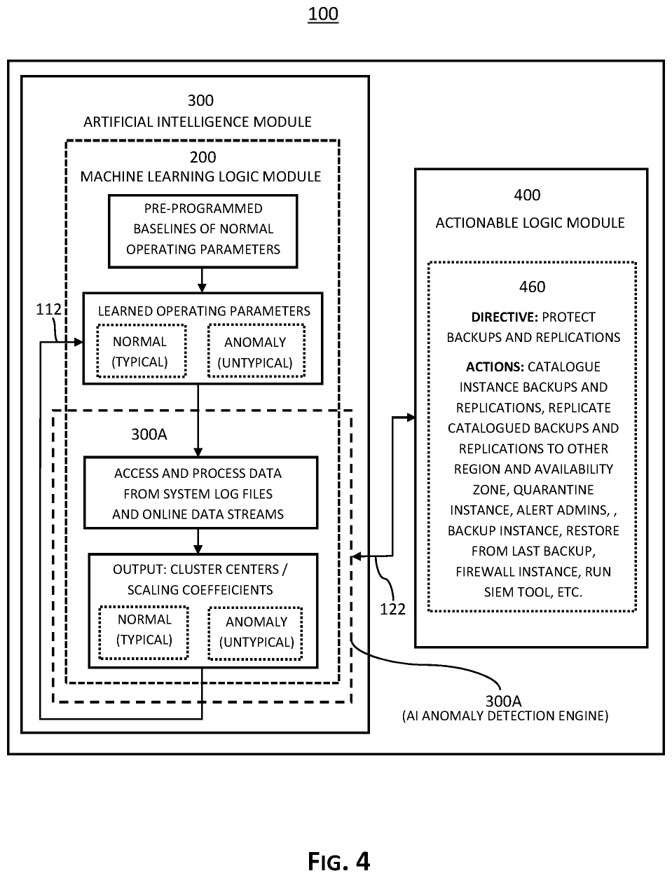

FIG. 2 is a functional block diagram illustrating an embodiment of the invention System 100 operative in an instance 60 (not referenced in FIG. 2) hosted on physical host machine 80 (not referenced in FIG. 2) within a virtual computing, cloud-based hosting service, such as, for example, an AWS ecosystem 00. Embodiments of System 100 comprise various inter-related processes or modules: artificial intelligence process/module 300, which is further comprised of machine learning logic process/module 200 and AI anomaly detection engine process 300A, and an actionable logic module 400 (see also alternative perspective schematic layout of FIG. 4). While FIG. 2 logically depicts an embodiment of the invention on the AWS ecosystem, and the AWS platform is utilized throughout this disclosure for purposes of describing embodiments of the invention, it is expressly understood that the invention is not in any way limited to the AWS cloud computing platform and that it may be applied to any number of known cloud computing platforms, such as Microsoft Azure or Google Cloud Computing or any other public or private cloud environments.

Continuing with reference to FIG. 2, in a cloud-based computing platform service, such as, for example, AWS (depicted in FIG. 2 as the outer most concentric dashed line 00 and termed “AWS Cloud”), a user of that service would either be assigned to or would necessarily decide to utilize the services of the provider located within a specific geographic region based on a number of variables. In the case of AWS, for example, cloud computing resources are hosted in multiple locations world-wide. These locations are composed of AWS “Regions” and “Availability Zones.” Each AWS Region is a separate geographic area and has multiple, isolated locations known as Availability Zones. Each AWS Region is completely independent. Each AWS Availability Zone is isolated, but the Availability Zones in an AWS Region are connected through low-latency links. With regard to FIG. 2, an AWS Region is graphically represented by the next innermost concentric dashed line 10 (termed “Cloud Region” in FIG. 2).

AWS provides users the ability to place resources, such as instances 60, and data in multiple locations; resources are not generally replicated across AWS Regions unless users do so specifically. AWS Regions currently established in the United States are shown in Table 1, below:

TABLE 1
AWS REGIONS (U.S.)

| Region Name | Region | Endpoint | Protocol |
|---|---|---|---|
| US East (Ohio) | us-east-2 | rds.us-east-2.amazonaws.com | HTTPS |
| US East (N. | us-east-1 | rds.us-east-1.amazonaws.com | HTTPS |
| Virginia) | | | |
| US West (N. | us-west-1 | rds.us-west-1.amazonaws.com | HTTPS |
| California) | | | |
| US West (Oregon) | us-west-2 | rds.us-west-2.amazonaws.com | HTTPS |

Continuing with FIG. 2, Cloud Region 10 (or, in the case of AWS, also referred to by those knowledgeable in the art and/or users of the AWS Cloud service platform as “Region” or “EC2 Region”) is designed to be completely isolated from the other Cloud Regions. This achieves the greatest possible fault tolerance and stability and therefore provides a first level or layer of security to an instance 60 operative therein. Regions are strategically designed for redundancy, reliability and security. Each AWS Cloud Region consists of multiple Availability Zones, discussed below, which are basically fully isolated partitions of infrastructure that consist of discreet data centers all with their own redundant power, networking and connectivity and housed in separate facilities.

Continuing with FIG. 2, users of the virtual cloud-computing platform, such as the AWS Cloud services considered here, create and define a virtual private cloud (“VPC”) in which to launch (e.g., create and/or migrate, etc. a VM or instance) their cloud computing resources for internet access and use by authorized users (authorized individuals, organizations, enterprises, etc. as determined by the ultimate user(S) responsible for operating and maintaining the cloud computing resources within one or more instances 60). The VPC is a virtual network that closely resembles a traditional network, such as a private network or virtual private network (VPN) operated in a data center, but with the benefits of using the scalable infrastructure of the virtualized platform such as that offered by AWS. The VPC is depicted as the next innermost concentric line 12 in FIG. 2 and represents the next inner layer or level of security for users of the cloud computing resources operative in one or more instances 60. With regard to AWS, a VPC is generally dedicated to a user's specific AWS account, and the user's VPC is logically isolated from other virtual networks in the AWS cloud platform. Users may launch various AWS resources, such as Amazon EC2 instances, into their respective VPC networks, specify an IP address range for the VPC, add subnets, associate security groups, and configure route tables.

Continuing with FIG. 2, after users of the virtual cloud-computing platform, such as that considered here—the AWS Cloud services—create and define a VPC, users add and define “subnets” within their respective VPCs. A subnet is a range of IP addresses in the VPC and a user may launch AWS resources into a specified subnet. In the case of AWS, users will add and define a “public subnet” for resources that must be connected to the internet, and a “private subnet” for resources that will not be connected to the internet. Referring to FIG. 2, a user defined subnet is depicted as the next innermost concentric line 14 in FIG. 2 and represents the next inner layer or level of security to an instance 60 operative therein. With respect to AWS, a subnet is “part of the network,” in other words, part of entire Availability Zone within which a user's cloud computing operations are located. Each subnet must reside entirely within one Availability Zone and cannot span zones. Using Subnets in conjunction with Security Groups, network access control lists and flow logs, security is maximized. Security Groups act as firewalls for associated instances controlling inbound and outbound traffic at the instance level. Network access control lists act as firewalls for the associated subnets controlling inbound and outbound traffic at the subnet level and flow logs capture information about the IP traffic going to and from the network.

FIG. 2A, with reference to FIG. 2, is a general schematic depiction of a typical AWS VPC 20 within a single AWS Region 10 comprising a public subnet and a private subnet in two (2) Availability Zones 32. While the representation of FIG. 2A, demonstrates the public and private subnets traversing two (2) Availability Zones, it is generally understood that users may utilize more than two (2) Availability Zones within a VPC that comprises private and/or public subnets. Continuing with FIG. 2A, Availability Zone 1 is designated by reference number AZ-1. Availability Zone 2 is designated by reference number AZ-2. The public subnet within AZ1 (SubnetPublicAZ1) is designated by reference number 14A-1. The private subnet within AZ1 (SubnetPrivateAZ1) is designed by reference number 14B-1. With respect to AZ2, the public subnet therein (SubnetPublicAZ2) is designed by reference number 14A-2 and the private subnet within AZ2 (SubnetPrivateZA2) is designated by reference number 14B-2. An instance 60 is operative within each Availability Zone for use by user(s) thereof and each instance 60 is comprised of the aforementioned respective public and private subnets 14. Operative within each instance 60 is an embodiment of System 100 providing data security and backup as detailed below. Each instance 60 of FIG. 2A is functionally connected to the other via router 06 within the VPC 12 and each instance 60 is functionally connected to a digital network (internet) 02 via the router 06 and internet gateway portal 04 in the AWS cloud 00.

Continuing with FIG. 2, after users of the virtual cloud-computing platform, the AWS Cloud platform/service, create and define subnets within their respective VPCs, users generally add and define one or more “security groups.” Referring to FIG. 2, a user defined “security group” is depicted as the next innermost concentric line 16 in FIG. 2 (termed “Security Group”) and represents the next inner layer or level of security to an instance 60 operative therein. A user-defined Security Group 16 on the AWS platform 00 acts as a virtual firewall that controls the data and communications traffic to and from one or more instances 60. When a user launches an instance 60, the user associates one or more Security Groups 16 with the instance 60 and further adds rules to each Security Group 16 (in accordance with AWS protocols) that allow traffic to or from its associated instances. As AWS Security Groups 16 exist within individual VPCs 12, when a new Security Group 16 is created by a user, it must be incorporated into the same VPC 12 as the resources it is intended to protect.

AWS Security Groups 16 associated with a respective instance 60 provide security at the protocol and port access level. As such, each Security Group 16—working much the same way as a firewall—contains a set of rules that filter traffic coming into and out of an instance 60. Generally, there are no “deny” rules. Rather, if there is no rule that explicitly permits a particular data packet, it will be dropped.

The actual rule set that filters traffic is made up of two tables: “inbound” and “outbound.” Since Security Groups 16 are stateful, users need not establish the same rules for both outbound traffic and inbound. As a result, any established rule that allows traffic into an instance 60, will allow responses to pass back out without an explicit rule in the “outbound” rule set. Each rule is comprised of four fields: “type,” “protocol,” “port range,” and “source.” The fields apply for both inbound and outbound rules.

Continuing with FIG. 2, an embodiment of the invention System 100 operative on an instance (VM) 60 is graphically depicted within the concentric line representing the Security Group 16 layer or level of security. The operative System 100 generally comprises an artificial intelligence module 300, which is further comprised of a machine learning module 200 and a, anomaly detection engine 300A, and an actionable logic module 400. The actionable logic module includes configurable action items 460 that may be established as automated or automatic once established, invoking such pre-determined actions that include, among other action items: alerting, backup, quarantine, restore, replication, shutdown and many other options in guarding the enterprise's data protection from being compromised by cyberattack and disaster. The artificial intelligence engine module 300 is the control and incorporates various processes in conjunction with machine learning logic module 200, anomaly detection engine 300A and actionable logic module 400, whereby data is continuously processed.

Continuing with FIG. 2, users of System 100 may access, configure and control various parameters, establish rules and definitions, and create and establish priority among various response actions 460 within actionable logic module 400 via a remote management platform console 20 that is functionally connected to System 100 via an HTTPS network connection 22 provided by the AWS Cloud platform 00. Access granted to other users, and permissions and authorizations associated therewith, may be based on having the essential credentials (e.g., authorized login name and associated passwords) with communications requiring security cryptography, e.g., encryption, in place for security purposes.

Continuing with FIG. 2, in an embodiment, users may access the remote management platform console 20 via a web browser wherein the console 20 appears as a web page or other file accessible for use by a web browser. Alternatively, the remote management platform console 20 may be a stand-alone software application installed and/or operative on a local machine or device such as a workstation, mobile device and the like. The console 20 comprises, generally, a graphic user interface, wherein users of the invention may access data compiled and analyzed by machine learning module 200 and AI anomaly detection engine 300A, pre-configure actionable items 460 within the actionable logic module 400, receive messages from the actionable logic module 400, review anomaly events, etc. Using the console 20, users may configure actionable logic module 400 in the form of what to do when an anomalous event related to ransomware is detected by the AI anomaly detection module 300A. For example, in an embodiment, a user may configure the actionable logic module 400 such that upon detection of an anomaly indicative of a security threat to an instance 60, System 100 automatically shut downs instance 60, or firewalls instance 60, or catalogues all related backups and replications related to the infected instance 60 for either automated or manually selectable restoration, or immediate replication of catalogued backups to an alternate AWS availability zone and region, in order to further protect the last line of defense, being restoration of a system from a clean and uncompromised backup, or any combination of the action items available for configuration by a user.

While FIGS. 2 and 2A discuss the cloud computing platform as consisting of the AWS ecosystem, including through the use of such components and features as the AWS Cloud 00, Cloud Region 10, VPC 12, Subnet(s) 14, Security Group(s) 16, it is expressly understood that such components, features and terms do not comprise the embodiments of the invention and that any such other cloud computing platform or ecosystem, whether public or private, including Microsoft Azure, Google Cloud Computing or any governmental or enterprise virtual private cloud may comprise similar features, elements and components as that described herein and that embodiments of the invention are not limited, directly or indirectly, to any specific cloud computing ecosystem. Discussion of the AWS cloud computing platform is only for illustrative purposes and presents an exemplary cloud computing ecosystem for use of System 100.

Instance (VM) 60 data backup is a critical means of prophylactic protection in the event an operative instance 60 is compromised, particularly through a security breach or APT, such as ransomware. Data backup is a process of duplicating data, or, as presented here, an instance (VM) 60, to allow retrieval of the duplicate set after a data loss event. Today, there are many kinds of data backup services that help enterprises and organizations ensure that data is secure, and that critical information is not lost in a natural disaster, theft situation or other kind of emergency.

Considering the AWS cloud computing ecosystem, AWS provides several backup resources which would be readily understood by users of the platform and those skilled in the art. In addition, many third-party providers also provide robust instance backup applications with various features allowing customization of the desired backup process which would also be readily understood by users thereof and those skilled in the art. While many such backup processes are available, a brief discussion of the available AWS backup options is helpful with the understanding that embodiments of the invention are not limited to any particular data backup system, method or process for cloud computing operations or operation of the systems, methods and process of the disclosed invention.

AWS provides various flexible, cost effective, and easy-to-use data storage options for instances. Each option has a unique combination of performance and durability and available storage options may be used independently or in combination to suit a user's requirements. Options and features available for instance backup in the AWS ecosystem include Amazon Elastic Block Storage (“EBS”), Amazon EC2 Instance Storage, Amazon Elastic File System (“EFS”) storage and Amazon Simple Storage Service (“S3”).

FIG. 2B is a schematic diagram depicting the various AWS data backup storage options relative to instances 60 operative on a physical host machine 80. AWS data (instance) backup storage options depicted in FIG. 2B include Amazon EBS data backup storage 24, Amazon EFS data backup storage 26, Amazon EC2 Instance Storage 28 and Amazon S3 data backup instance storage 30. Each data (instance) backup system of FIG. 2B is comprised of at least one data backup (instance) memory/disk storage device 40, configured and formatted as at least one logical volume (not depicted), and each data (instance) backup system is functionally connected to an associated instance 60 operative on a host machine 80. In addition, it is also understood that each of the AWS data backup storage systems of FIG. 2B may be configured to backup data, in general, or an entire instance 60, or any portion(s) and/or combinations thereof as may be desired by a user of the respective backup system.

Continuing with FIG. 2B, the EBS backup storage system 24 provides durable, block-level storage volumes (not depicted) configured and formatted on at least one data backup (instance) memory/disk storage device 40, that users may attach or associate to a running instance 60. The EBS data backup storage system 24 may be used as a primary storage device for data that requires frequent and granular updates, for example, when running a database on an instance 60.

The EBS storage volume operative on one or more data (instance) backup memory/disk storage devices 40 behaves like a raw, unformatted, external block storage device that may be attached to a single instance 60. The volume persists independently from the running life of an instance 60. After an EBS volume (defined and configured by a user) is attached to or associated with an instance 60, it operates like any other physical hard drive. Referring to FIG. 2B, multiple volumes, operative on one or more data backup (instance) memory/disk storage devices 40, may be attached to an instance 60. Users may also detach an EBS volume from one instance 60 and attach it to another instance 60 (see Instance A 60 and Instance B 60 of FIG. 2B). Users may also dynamically change the configuration of a volume attached to an instance 60. EBS volumes may also be created as encrypted volumes using the Amazon EBS encryption feature.

Continuing with FIG. 2B, users may also create backup copies of data and/or instances by creating a “snapshot” 34 of an EBS volume which is then transmitted to and stored in AWS S3 Storage 30. Users may then create an EBS volume from a snapshot 34 and attach it to, associate it with or incorporate it within another instance 60. A point-in-time snapshot 34 of an EBS volume may be used as a baseline for new volumes or for data backup. Users may make periodic snapshots of a volume whereby the snapshots are incremental—only the blocks on the EBS volume that have changed after the last snapshot 34 are saved in the new snapshot 34. Even though snapshots 34 are saved incrementally, the snapshot 34 deletion process is designed so that users need to retain only the most recent snapshot in order to restore an entire EBS volume.

With regard to the AWS ecosystem, Amazon Machine Images or “AMIs” are also an important image backup especially for Windows servers because snapshots alone do not capture the content of the root volume of the Windows server, where the operating system resides. AMIs in conjunction with snapshots provide the ability for a complete restoration to be performed. Embodiments of the invention, as described in detail herein, provide the ability to maintain and catalogue as well as replicate (copy elsewhere to a designated AWS region), quarantine (copy backups to an alternate, secure area, restore, all AMIs and snapshots (collectively known as backups) of machines which may be stored anywhere within the AWS regional, global ecosystem.

Continuing with FIG. 2B, Amazon EFS data backup storage 26 provides scalable file storage. Users may create an EFS file system and configure instances to mount the file system. Users generally use an EFS file system as a common data source for workloads and applications running on multiple instances 60.

Lastly, continuing with FIG. 2B, instances 60 may be configured to access storage from disks 40 that are physically attached to or operative on host machine 80. This disk storage is referred to as instance storage 28. Instance storage 28 provides temporary block-level storage for instances 60. The data on an instance store volume 28 persists only during the life of the associated instance 60; if a user stops or terminates an instance, any data on the associated instance store volume 28 is lost.

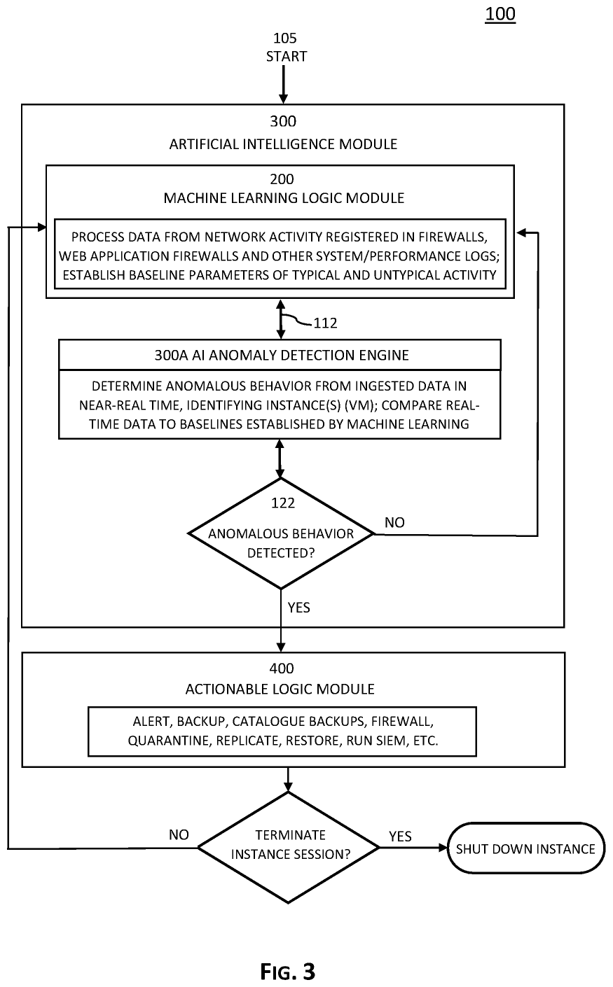

FIG. 3 is a process, method and system flow diagram of an embodiment of System 100 depicting artificial intelligence module 300, which is further comprised of machine learning module 200 and anomaly detection engine 300A, and actionable logic 400 module operative within an instance 60 in a virtual, cloud-based computing platform, such as the AWS Cloud service/platform, in the general manner as previously described. The flow diagram of FIG. 3 shows the functionality and operation of an embodiment of the invention with the various modules/processes/element depicted comprising various computer implemented code comprising one or more executable instructions for implementing the specified functions(s) described therein all operative within an instance 60 operative on a host machine 80 in a cloud environment that is functionally connected to one or more backup systems, such as those depicted in FIG. 2B.

Referring to FIG. 3, Step 105, Start, represents initiation and commencement of operations when System 100 is launched and operative within an instance 60. While machine learning logic module 200 is depicted as an initial step in FIG. 3, in an operative state, machine learning logic module 200 and AI anomaly detection engine 300A are inter-related and operate concurrently in embodiments as further described herein. Module 200 utilizes machine learning in compiling and processing data from network, host machine and/or instance activity registered in the system and events logs of instance firewalls, web application firewalls and other system and performance logs of instance 60 and host machine 80. Such data is mined, ingested, compiled, processed and analyzed by module 200 to establish one or more baseline system parameters that define routine, normal and non-compromised activity, i.e., “typical” activity or behavior, in instance 60. With increased operations of instance 60 and System 100 operative thereon, in terms of time and volume of inbound and outbound data traffic, machine learning logic module 200 is able to continually learn from the continuous data flow and establish more refined and accurate system parameter baselines indicative of normal, routine and non-compromised operations of the respective instance. In embodiments, various baseline parameters are established and programmed into machine learning logic module 200 prior to launch of System 100 and serve as starting points for module 200.

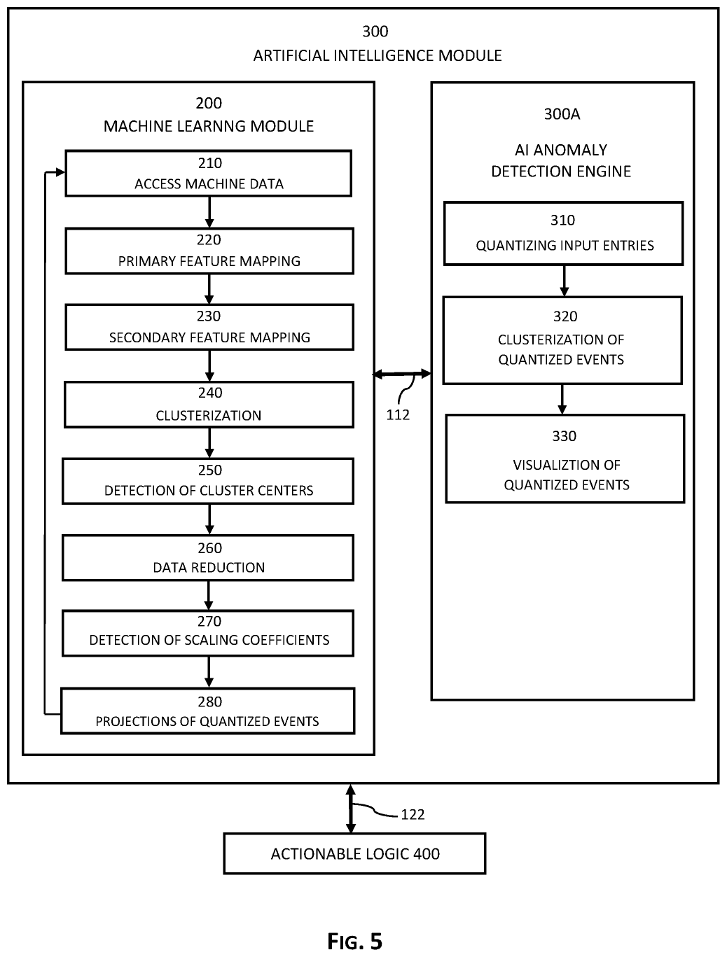

Continuing with FIG. 3, artificial intelligence anomaly detection engine 300A works in conjunction with machine learning module 200 to continuously and in real time monitor system and event logs and compare with established baseline parameters, as are continuously refined by machine learning logic module 200, to detect anomalous events or behavior that may signify an APT or other cyber-attack, threat or activity, such as, for example, a ransomware attack. It is to be understood that with embodiments of the invention, machine learning module 200 and artificial intelligence anomaly detection engine 300A are interrelated and run concurrently (as supported by interface arrow 112 pointing in both directions and further supported by FIGS. 4 and 5 and the descriptions thereof). Module 200 and anomaly detection engine 300A of artificial intelligence module 300 are depicted separately for illustrative purposes only in FIG. 3. Continuing with FIG. 3, anomaly detection engine 300A of artificial intelligence module 300 makes determinations of anomalous behavior, activity or threats by comparing the continuously updated baseline parameters created by the machine learning logic module 200 with detection engine's 300A ingestion of real-time online compilations of the same data sets, as described further within, to identify statistically supported anomalous behavior or activity indicative of an APT, incursion, attack or other such like threat. At step 122, if no such anomalous behavior or activity is detected, System 100 continues to process machine data and online data streams as part of its ongoing machine learning logic 200 process. On the other hand, at step 122, if anomalous behavior or activity is detected, i.e., behavior or activity outside of the baseline parameters established in machine learning module/process 200 (atypical activity), then System 100 proceeds to step 400, actionable logic module, wherein module 400 may initiate and implement any number of action items ultimately directed towards protecting and preserving one or more data backups. Such action items include, but are not necessarily limited to, alerting users of System 100 of the anomalous behavior/activity, running one or more backups of data or data sets, including backups to other Cloud Regions, accounts, or cloud systems or platforms, initiating various firewall activities to protect already existing data backups from intrusion and compromise by the threat (i.e., shutting all means of access to such data backups), quarantining the threat and/or instance to prevent further spread of the threat, replicating the existing backups to other Cloud Regions, accounts or cloud systems or platforms (including quarantining the actual backups by storing them within any location mentioned above and adding further known, as well as potential proprietary cybersecurity protections), such as, for example, Microsoft Azure or Google Cloud, restoring an instance backup to the original instance location, running security information and event management (“SIEM”) tools and services as provided by AWS, other cloud platform service or such any other third party, etc. In addition to implementing any action item, or any combination of action items, System 100 may proceed to terminate an instance 60 session by shutting down the VM/instance 60 or host machine. If the VM/instance session or host machine is not shut down, System 100 would continue its machine learning as provided in module 200.

Within the actionable logic module 400, based on the detected anomaly, various alerts and actions may be triggered such as those more passive in nature, e.g., notifications to system and security admins, or those more active in nature, e.g., pause or stop instance/VM, invoke backup of instance/VM, etc., or any combination of such available action items. The actionable automation is inclusive of performing backup to other regions, backup cataloguing of existing backup(s) (AWS worldwide cross-region and cross-account), quarantine of instance AMIs and snapshots regardless of region stored, quarantine of instance, firewalling the instance, replication, performing restore from existing backup, shutting down network ports and connectivity, running SIEM tools, etc.

FIG. 4 is an alternative schematic flow chart perspective of System 100 depicting artificial intelligence module 300, further comprised of machine learning module 200 and anomaly detection engine 300A, and actionable logic module 400. FIG. 5 is detailed schematic flow chart of the processes implemented by artificial intelligence module 300, with machine learning logic 200 and AI anomaly detection engine comprised in the steps depicted therein. FIGS. 3, 4 and 5 are to be viewed together as various features and elements are cross-referenced therein. Following is a detailed description of FIG. 5 with the understanding that it is to be viewed in context of FIGS. 3 and 4.

FIG. 5 is detailed schematic flow chart of artificial intelligence module/process 300 which further comprises machine learning logic module/process 200 and AI anomaly detection engine 300A, wherein said module/process 200 accesses, compiles and processes various data from network activity registered in the system and events logs of instance firewalls, web application firewalls and other system and performance logs of instance 60 and host machine 80 to create baseline parameters indicative of routine, normal and non-comprised instance operations and activity, and wherein anomaly detection engine 300A monitors and analyzes in near real time that same data as that data is generated from systems logs as well as online data streams and compares its statistical analysis of same to the baseline parameters established by the machine learning module 200 for anomalous activity indicative of a threat to the data and data backups of an instance 60. The data ingested by module 200 are entries of events from machine data or digital information created by the activity of the VMs, host machines or other networked devices in system, network and performance logs, where network activity and performance indicators of instances (VMs) from Internet cloud services provided by Amazon, Microsoft, etc. are registered. Sources for such machine data or digital information that are accessed, compiled, interpreted and processed by the machine learning process 200 and engine 300A include, but are not limited to, system logs of the instance 60 and host machine 80 (regardless of the OS, e.g., Windows, Linux, etc.) including file system, syslog, configurations, registry and event logs, hypervisor logs, app logs, web logs, .net event logs, tables, schemas, snmp, netflow, ids, VPC flow logs, DNS logs, CPU, memory, disk activity, network traffic, as well as CloudTrail event log analysis. These logs are generally stored as log files within specific OS folders or application folder areas and accessed/copied elsewhere by the machine learning logic module 200 for analysis. While modules of embodiments depicted and described compile data from various sources, it is to be expressly understood that machine learning module 200 may further access, compile and process data as described with respect to engine 300A and that engine 300A may further access, compile and process data as described with respect to module 200. As such, while embodiments may be described with respect to particular data sources—whether local system logs or online data streams—it is expressly understood that various modules of embodiments are not limited to any particular set or sets of data sources.

In the context of computing, a log or log file is generally a text file or XML, file used to register the automatically produced and time-stamped documentation of events, behaviors and conditions relevant to a particular system. Generally, the events recorded by the log file are often predetermined by the operating or other system itself and may contain information about device changes, device drivers, system changes, events, operations and more. While log files are generally associated with an operating system or OS of a machine (virtual or host), they are used in many such other environments, including, but not limited to, the following:
On a web server: an access log can be useful to identify number of visitors, the domains from which they are visiting, the number of requests for each page, usage patterns according day of the week or even the hour of the day.
Operating system: use syslog files to register events, errors, user access, warnings, etc. By reviewing its data, an administrator can check if all processes are loading successfully or the root cause of a specific problem.
In Microsoft Exchange: transactions logs are files used to convey information (email messages, new users, folders deleted, etc.) to the database of Exchange. Everything is sent first to the transaction log and then to the database when the system allows it.
In network routers: log files register failing processes, connections and disconnections from wan services and devices, VPN connections status, etc.
In firewalls: log files register which network connections were allowed and dropped.

Logs have standard components that may vary depending on the OS. However, there are common components and information that are captured regardless of the OS. All entries are classified by type such as error, information, warning, success audit and failure audit for Windows systems, and emergency, alert, critical, error, warning, notice, info and debug for Mac OS and Linux systems. Events are classified into System, Security, Application, Directory Service, DNS Server & DFS Replication categories. Directory Service, DNS Server & DFS Replication logs are applicable only for Active Directory. Events that are related to system or data security are called security events and its log file is called Security logs.

TABLE 2

| Event Log Type | Description |
|---|---|
| Application Log | Any event logged by an application. These are determined by the |
| | developers while developing the application. With a Windows OS, |
| | where applications hosted in the local machine, including a VM |
| | operative on a host machine, send their messages to. An example: An |
| | error while starting an application gets recorded in Application Log. |
| System Log | Any event logged by the Operating System. Eg.: Failure to start a drive |
| | during startup is logged under System Logs |
| Setup Log | This log holds messages captured during the OS installation. With a |
| | Windows OS, if the machine has been set up as a domain controller, the |
| | messages will be captured here. |
| Security Log | Any event that matters about the security of the system. This log holds |
| | information related to login attempts (success or failure), elevated |
| | privileges, among other items. Example: valid and invalid logins and |
| | logoffs, any file deletion etc. are logged under this category. |
| Forwarded Events Log | With a Windows OS, these events are “sent” by other computers when |
| | the local machine is acting as a central subscriber to those machines. |
| Directory Service Log | Records events of AD. This log is available only on domain controllers. |
| DNS Server Log | Records events for DNS servers and name resolutions. This log is |
| | available only for DNS servers |
| File Replication Service | Records events of domain controller replication This log is available |
| Log | only on domain controllers. |

Some of the events listed above include system errors, warnings, startup messages, system changes, abnormal shutdowns, etc. This list is applicable to most versions of the three common OSs (Windows, Linux and Mac OS).

Continuing with FIG. 5 (viewed in context with FIGS. 3 and 4), machine learning module/process 200 and anomaly detection engine 300A are based on constructive algorithms for processing and identifying events registered in the above-mentioned system logs. Ideologically, algorithms employed by System 100 may be based on a combination of two well-known approaches: fuzzy sets theory (the fact that the event is “typical” or “atypical” is determined by the value of its membership degree) and the method of potential functions (the metric properties of events are determined with the help of a nonnegative symmetric kernel of one or another form). From a theoretical point of view, such processes/algorithms that may be employed by System 100 are adaptive learnings algorithms that allow for identification of evaluated events. From a practical point of view, such processes/algorithms may provide an opportunity to simultaneously estimate the degree of “typicality,” calculate 3D coordinates, and provide computer visualization of these events. That is, embodiments may further provide to users various graphical depictions or representations, such as, graphical depictions on a computer display or monitor or thorough any such device (e.g., mobile device) capable of graphics display, of data comprising typical and/or atypical events so that users may visually see the data monitored and analyzed by System 100 from which the actionable logic module initiates pre-configured action items directed towards the protection of data backups.

Algorithms/processes employed by System 100 further allow for the detection of intrusions, malicious activity, and other anomalies of network activity registered in firewalls, web application firewalls or other system/performance logs, including pattern matching logic. The estimation of the “typicality” of events may be considered as the quantitative analysis of the studied system logs entries, while the visualization may be considered as their qualitative analysis.

In embodiments, functionality of the machine learning 200 and anomaly detection engine 300A processes—while inter-related and overlapping—may be separated into two phases: learning and classification. In embodiments, machine learning module 200 is generally comprised of the learning phase, which, in embodiments, is further comprised of seven steps, the last of which may be considered as optional. Input data is primarily comprised of system log entries that describe events that occur to or within instances (VMs) operating in standard operating mode. In embodiments, AI anomaly detection engine 300A is generally comprised of the classification phase, which, in embodiments, is further comprised of three steps, the last of which may be considered as optional. Data sources for the classification stage are primarily, but limited to, online data streams as described below.

FIG. 5 depicts both the learning stage functions of machine learning logic module/process 200 and the classification stage functions of AI anomaly detection engine 300A. In embodiments, the learning stage steps of machine learning module 200 and the classification steps of engine 300A run independently and concurrently and while described and depicted separately in FIG. 5, are integrally related as comprising the overall machine learning 200 and artificial intelligence 300 functional process of System 100 (see FIG. 4). This is supported by the double pointed arrow in FIG. 5.

Referring to FIG. 5, at step 210, machine learning module/process 200 accesses an instance's 60 system logs or the system logs of the host machine 80 or any other machine, firewall or system functionally connected to an instance 60 wherein various system logs, as previously described, may be located. Data from the logs is accessed and copied at step 210 for compilation, analysis and processing in accordance with various embodiments described.

Continuing with FIG. 5, at step 210, machine learning module 200 accesses the log files within the associated VM 60 in which System 100 operates, as well as that of the physical machine 80 hosting the VM/instance 60. Machine learning module/process 200 is programmed to locate and access such log files according to methods generally widely known and utilized by those skilled in the art. For example, in a Windows system (VM 60 and/or host machine 80), the machine data stored within logs may be generally located on the system disk, usually C: and the path is: system drive: \Windows\System32\ Winevt\Logs. On a Linux VM 60 or host machine 80, log files may be generally found in the /var/log directory and subdirectory. There are Linux logs for everything from system, kernel, package managers, boot processes, Xorg, Apache, MySQL, etc. From the perspective of the AWS cloud environment, on the other hand (and as discussed in greater detail, below, particularly with regard to AI anomaly detection engine 300A, VPC flow logs and other log files are created and accessible via one or more AWS application programming interfaces or “APIs” made available by AWS. Using AWS APIs, flow logs may be created and retrieved via CreateFlowLogs (Amazon EC2 Query API) and GetLogEvents (CloudWatch API) respectively. In addition, logs may also be created and retrieved via Microsoft PowerShell as well as through the AWS CloudWatch service, which collects monitoring and operational data in the form of logs, metrics, and events, providing a unified view of AWS resources, applications and services that run on AWS, and on-premises servers.

Continuing with FIG. 5, step 220 of the machine learning logic module 200 comprises primary feature mapping. The data of instance (VM) system logs are dynamic in nature, i.e., continually compiled by the OS 64 of the instance 60 and host machine 80, thereby resulting in massive amounts of data accumulating on a continuous basis. In order to track the dynamics, the events are quantized with respect to time. To this end, at step 220, a quantizing interval, which may be adaptively variable, is chosen and all the entries describing the events accrued within it are fixed. Further, at step 220, in embodiments, a sufficiently representative set of statistics is calculated and recorded for the fixed events. In particular, the following representative set of statistics is calculated and recorded at step 220 for the fixed events:
the initial and final time of quantizing interval (two dates),
the number of unique addresses of incoming and outcoming requests (two numbers),
the number of incoming and outcoming requests (two numbers),
the number of incoming and outcoming packages (two numbers), and
the number of incoming and outcoming bytes (two numbers).
   In embodiments, other statistics may be calculated and step 220 is not limited to the foregoing (i.e., calculation of other statistics is optional). The values of the calculated statistics are recorded to a table whose entries are quantized events of the system log.

Continuing with FIG. 5, step 230 of machine learning module/process 200 comprises secondary feature mapping. Step 230 comprises a machine learning kernel function applied to the space of quantized events, i.e., to the entries of the table constructed at step 220. The choice of a kernel function, e.g., Gaussian, polynomial, etc., is grounded on the application area. The values of the kernel function generate a square kernel matrix whose dimension is equal to the number of quantized events. As this number may be significant, in order to expedite the kernel matrix computations, the process may be parallelized, for example, with respect to the rows. The kernel matrix is constructed, thereby determining the map of the quantized event to a Hilbert space so that it is possible to measure distances and angles between them.

Continuing with FIG. 5, step 240 of machine learning module/process 200 comprises clusterization. At step 240, the metric relations between the quantized events constructed at step 230 are analyzed for clusterization. In embodiments, the entries of the kernel matrix rows are sorted in ascending order and several maximal elements of each sorted row are added together. The number of the elements to be added may be fixed, for example, at twenty percent (20%) of the total number of the entries in a row or chosen adaptively, for example, by means of the condition that the last added element is less than or equal to a set value, e.g., half of the maximal element in the row. Further, in embodiments, the matrix row that provides the greatest sum is chosen and a cluster is generated by the quantized events corresponding to the summands from the chosen row. The rows and columns responding to this cluster are excluded from the kernel matrix and construction of the next cluster is performed in an analogous way. A condition for termination of the iteration process as described herein may be, for example, an upper limitation for the number of constructed clusters or/and an adaptive criterion, for example, a sufficiently small value of the current greatest sum.

As a result, at step 240, a number of clusters is constructed. Each cluster models a behavior of a homogeneous group of “faithful” (i.e., “typical”) or “malicious” (i.e., “atypical”) users. Such clusterization is analogous to a reduction of the kernel matrix to a block-triangular form. In this sense, “faithful” means that the events should be “trusted”—meaning part of the baseline of events collected during this learning step and further assuming no malicious events have occurred. “Malicious,” on the other hand, means that the events data has deviated from the baseline. In this manner, baselines of routine, non-compromised operative behavior and activity may be constructed.

Continuing with FIG. 5, in embodiments, step 250 of module/process 200 comprises detection of cluster centers. For each of the clusters compiled, created or constructed at step 240, a geometrical center is detected by the module at step 250. For this purpose the method of the least squares (a standard approach in regression analysis to approximate the solution of overdetermined systems, i.e., sets of equations in which there are more equations than unknowns; “least squares” means that the overall solution minimizes the sum of the squares of the residuals made in the results of every single equation) and SVD (“singular value decomposition,” a factorization of a real or complex matrix) are applied to the corresponding blocks of the kernel matrix. Optionally, in embodiments, a fuzzy set approach is used. As the number of quantized events in a cluster may be enormous, in order to expedite the process of detecting cluster centers, and to preserve computational resources and cycles, cluster center detection computations may be parallelized with respect to clusters.

As a result, in step 250, a number of cluster centers is constructed. Each center is a linear combination that, generally speaking, comprises all the quantized events from the corresponding cluster.

Continuing with FIG. 5, in embodiments, step 260 of machine learning logic module/process 200 comprises data reduction. The cluster center data constructed at step 250 comprises linear combinations of quantized events that may comprise a significantly large number of summands so that their immediate usage for classification may be time-consuming, require substantial computation resources, and may not be acceptable for online operating processes or algorithms. To expedite the classification, in embodiments, the number of summands may be effectively reduced by approximating the quantized events from each cluster by basis events. For this purpose, in embodiments, a technique that concerns a fuzzy Sugeno integral may be applied. For higher efficiency, and to further expedite the process and preserve computer resources, the computations provided in step 260 may be parallelized with respect to clusters.

As a result, in step 260, a number of reduced linear combinations is constructed, one combination per cluster. In an embodiment, each linear combination of step 260 comprises a small number of basis events and sufficiently approximates the geometrical center of the corresponding cluster.

Continuing with FIG. 5, in embodiments, step 270 of machine learning module 200 comprises detection of scaling coefficients. The primary objective of the classification processes of AI anomaly detection engine 300A, discussed below, is the creation of membership degree functions of events (typical and atypical) from system logs to the clusters. To achieve this, in embodiments, at step 270 a technique of optimal detection of scaling coefficients may be applied. As above, for higher efficiency, and to further expedite the process step 270 and preserve computer resources, the process of detecting scaling coefficients may be parallelized with respect to clusters.

As a result, in step 270, a number of scaling coefficients is constructed, one coefficient per cluster.

Continuing with FIG. 5, in embodiments, step 280 of machine learning module/process 200 comprises construction of projections of the quantized events. In some cases, aside from an automatic command to initiate a backup of an instance (VM), generation of a report for a user, such as, for example, a system administrator, may be an additional optional goal at the classification stage (discussed below). That is, a visual report that may be reviewed by a user may be desirable. To generate a visual report depicting various aspects of the processes employed by embodiments of the invention, an embodiment may further comprise an additional step wherein functions are applied to project the data of quantized events to three-dimensional Euclidian space.

As such, in embodiments and continuing with FIG. 5, at step 280 of machine learning logic module/process 200, a number of functions for constructing or creating a projection of quantized events to three-dimensional Euclidian space is performed, one function per cluster. These functions may therefore provide for interactive visual depictions of the events undergoing classification in the classification stage, which may be displayed on a computer monitor or such other display technology, including, but not limited to, mobile devices, or any such other device with graphics display capabilities.

Summarizing the learning stage/phase functional processes of machine learning logic module/process 200 of embodiments as depicted in FIG. 5, the input data of the process comprises, among other data, instance (VM) system logs of entries describing the sequences of events that occur in standard, routine (typical) operating mode (i.e., baseline parameters indicative of typical activity) with no real or attempted security threat to the operations of the instance. The output of the learning stage of machine learning logic module 200 is the set of: 1) cluster centers, each of which is a linear combination of basis quantized events, 2) scaling coefficients, one coefficient per cluster, and 3) optionally, functions of projection to three-dimensional Euclidian space, one function per cluster.

Continuing with FIG. 5, in embodiments, AI anomaly detection engine 300A of the artificial intelligence module 300, and the various classification process steps thereof, is depicted. In embodiments, engine 300A comprises three classification steps, the last of which may be considered as optional. In addition, in embodiments, unlike machine learning module 200, wherein input data is generally obtained and derived from instance system logs, input data for the engine 300A is generally comprised of data from entries in the system logs obtained and read from online streams. Online streams of data are generally transmitted to and received and processed by the module engine 300 in real or near real time. Data from instance log files, on the other hand, are generally stored within the operating system 64 of the instance 60.

As used herein, “online streams” of data refers to the data streams made available by and through a cloud computing platform/ecosystem, such as, for example, AWS, to users of that service, and provided in real-time or near real-time and not stored locally in system log files within an instance. Examples of data from online streams include, but are not limited to, such data derived or originating from instance firewalls, web application firewalls, VPC flow logs, VPC flow logs, DNS logs, network traffic logs, AWS CloudTrail logs, netflow logs, snmp logs, network traffic logs, and the like. As previously noted, from the perspective of the AWS cloud environment, for example, VPC flow logs and other log files are created and accessible via one or more AWS APIs made available by AWS. Using AWS APIs, flow logs may be created and retrieved via CreateFlowLogs (Amazon EC2 Query API) and GetLogEvents (CloudWatch API) respectively. Logs may also be created and retrieved via Microsoft PowerShell as well as through the AWS CloudWatch service, which collects monitoring and operational data in the form of logs, metrics, and events, providing a unified view of AWS resources, applications and services that run on AWS, and on-premises servers. All of the above represent examples of “online streams” of data used by embodiments that originate from the cloud ecosystem and not necessarily within the operative instance.

Referring to FIG. 5, in embodiments, step 310 of AI anomaly detection engine 300A comprises quantizing input entries. Step 310 of FIG. 5 is nearly identical to step 210 of the machine learning logic module 200 but, as noted, applies to online streams of data ingested from system logs thereof. In step 310, the continuous range of values of input entries are converted to a finite range of discreet values.

Continuing with FIG. 5, in embodiments, step 320 of AI anomaly detection engine 300A comprises clusterization of quantized events. In step 320, engine 300A utilizes the set of cluster centers and the scaling coefficients compiled and created during the learning phase of module 200 to calculate estimates of the membership degree of the quantized events from step 310. That is, the quantized events from step 310 are assigned a membership degree indicative of potential malicious (atypical) activity in step 320. Quantized events with a high membership degree, for example, would signify a malicious (atypical) event and are recorded to a cluster or grouping for such quantized events. If the frequency of events that belong to “malicious” clusters or having anomaly nature are sufficiently high, then the actionable logic 400 for protecting backups and taking action per the configuration established therefor by a user against the malicious event is initiated.

Continuing with FIG. 5, in embodiments, step 330 of AI anomaly detection engine 300A comprises visualization of quantized events. By means of the projection functions constructed in machine learning module 200 at step 280, the quantized events compiled by AI anomaly detection engine 300A may be interactively visualized on a computer monitor, display or any other device with graphics display capabilities. The visualization of the quantized events of the system logs may assist users in tracking overall security impacts to the instance.

To summarize, input data of AI anomaly detection engine 300A comprises online data streams describing sequences of events occurring to the instance 60. The output is estimates of the membership degrees of the quantized events to the corresponding clusters, step 320, with optional opportunity of their visualization, step 330.

Upon the determination or detection of anomalous or malicious activity as described above, i.e., atypical behavior activity, System 100 proceeds to initiate one or more action items 460 in actionable logic module 400 as have been preconfigured by users. Such anomaly or atypical activity as determined by embodiments of System 100 may be range from any number of malicious and destructive events at the instance 60, host machine 80 or cloud ecosystem level, and include such items as rogue processes performing damaging actions on known system files, deleting or renaming system files, mass file encryption, mass file changes are any number of general patterns indicative of a ransomware attack. Other such actions indicative of a ransomware attack that embodiments of the invention would detect in accordance with the above method and process, and therefore determine as anomalous or atypical activity, include, but are certainly not limited to events such as: process-based modification of a file in a system folder, process-based modification of an executable file, excessive or spikes in computer, system or network activity, process-based deletion of a command or executable file, process-based creation of an executable file in a user folder, process-based modification of a file in a user directory, processed-based modification of an autorun registry key value, process-based execution of a command or execution file, deletion of a shadow copy, process-based disabled proxy, process-based disabled firewall, etc.

The actionable logic module, as previously described and depicted in FIGS. 2, 3 and 4, comprises various action items 460 preconfigured or selected by users of System 100, such as a system administrator. The action items 460 available for pre-configuration may be presented to a user as a checklist or menu selection options via the remote management platform console 20, wherein a user selects the various action items to be automatically initiated by System 100 when anomalous activity is detected by the AI anomaly detection engine at step 122 (see, e.g., FIG. 3). The objective of such automated action by System 100 is to immediately preserve and protect data backups at the first indication of anomalous activity, particularly APTs such as ransomware.

Action items 460 of the actionable logic module 400 that may be automatically initiated by System 100 based on the pre-configuration thereof by a user include, but are not limited to, the following:

Catalogue Instance Backups.

Referring to FIG. 2B, instance backups may be numerous and stored in various locations relative to the operative instance 60, such as, with regard to the AWS platform as an example, within AWS Instance Storage 28, Amazon EBS Storage 24, Amazon EFS Storage 26 and Amazon S3 Storage 30. By cataloguing instance backups, the actionable logic module 400 creates an internal list of all instance backups and replications regardless of where stored in order to potentially protect one or more of such backups and/or replications by copying, replicating and storing elsewhere. All instances are viewed as objects and are identifiable via an assigned instance ID. An instance ID is a device identification string that distinguishes a device (instance) from other devices (instances) operative on the same host machine 80. An instance ID contains serial number information, if supported by the underlying bus, or some other form of location information.

In an embodiment, when an anomaly indicative of malicious behavior is detected, the actionable logic module 400 recognizes the operative instance 60 affected thereby and reads the instance ID of the instance 60 and catalogues all of the associated backups and replications wherever they may be stored anywhere in the world throughout the regional AWS ecosystem that are associated with and belonging to that instance ID for potential copying and replication.

Copy/Replicate Catalogued Instance Backups and Replications.

Continuing with FIG. 2B, once all instance backups and replications have been catalogued, based on the pre-configuration of action items 460 by a user, the actionable logic module 400 may then replicate and/or copy one or more such backups and/or replications to other regions to protect them from infection and to preserve the backups and/or replications from a ransomware event. By copying and/or replicating instance backups and replications to other locations, actionable logic module 400 of System 100 prevents a ransomware attack from encrypting such instance's backups and replications, thereby affording the last line of defense in recovering from a manmade disaster, like ransomware. Continuing with FIG. 2B, as an example, a copy of an instance backup stored in Amazon EBS Storage 24 may be replicated as an AMI or other image “snapshot” 34 in Amazon S3 Storage 30. This is just but one example of the many available options to users of System 100 in preconfiguring action items 460 as part of actionable logic module 400 operations. Replications may be made to other regions, data centers or accounts (which may comprise different login identification credentials and passwords within different data centers for added security and access). In addition, it is to be further understood that the available action items 460 of module 400 may also be conducted manually by users at any time, whether as a matter of routine backup protection or in the event that the user is notified through an alert issued by module 400 as a result of an anomaly detection.

Quarantine.

Actionable logic module 400 may also be preconfigured to quarantine the instance 60 affected by the anomalous activity to prevent spread of an APT/ransomware infection to existing data backups and/or replications, regardless of where stored. In addition, actionable logic module 400 may also be preconfigured to quarantine one or more existing catalogued backups and/or replications regardless of cloud cross-region and cross-account stored to prevent further incursion by the APT/ransomware attack. Quarantine may also be performed to a specific host machine 80, also to prevent further incursion by the APT/ransomware attack.

Alert.

Actionable logic module 400 may also be preconfigured to transmit one or more alerts to one or more users of System 100. Alerts may be transmitted to authorized, pre-determined (designated) users (such as an administrator) or any such other individuals in the form of Simple Notification Service (“SNS”), email, voice call and text message. All such alert methods are generally well known, and others not specifically mentioned are intended for inclusion herein and the available alerts are not limited to those specifically listed.

Backup.

The actionable logic module 400 may also be preconfigured to perform an immediate backup of the instance 60 affected by the anomaly. A backup of the instance 60 may be desirable as an attempt to preserve the last known data of the instance in the event it has not been fully infiltrated by the threat and potentially recoverable. Referring to FIG. 2B, backups may be copied and stored to any number of generally known and recognized backup locations. In the context of the AWS ecosystem, such locations may include AWS EBS Storage 24, AWS EFS Storage 26, AWS Instance Storage 28 and/or AWS S3 Storage 30 or any combinations of the foregoing. Backups may be directed by actionable logic module 400 towards any commonly used backup systems and methods used by instance 60 for performing routine backups, including those provided by the AWS platform or by way of third-party applications. In an embodiment, the actionable logic module 400 may comprise a backup utility function for purposes of performing such backups as may be preconfigured by a user.

Restore Instance.

Actionable logic module 400 may also be preconfigured to perform an immediate restoration of a backup of the instance 60 affected by the anomaly. Such backups or replications may be stored in any of the locations previously discussed with regard to the AWS ecosystem described in FIG. 2B. Conducting an immediate restoration of an instance backup allows for minimal, if any, downtime of the instance in the event of an attack, thereby allowing seamless usage of the instance by users.

Shutdown.

Actionable logic module 400 may also be preconfigured to shutdown the instance 60 to prevent further infestation of the threat to data backups and/or existing replications of the instance. Shutdown may take many forms, including, shutting down network connectivity to the instance 60, shutting down one or more ports to the instance, terminating operation of the instance, shutting down (turning off) the host machine 80, or any combination of the foregoing.

While many potential action items 460 have been described with respect to the actionable logic module 400 that uses may select and preconfigure in the event of an anomaly, it is to be expressly understood that there are many variations of the items so described and other related items that module 400 may include for pre-configuration that are not listed here. One skilled in the art would readily appreciate any such other items that may be desirable as effective response means to an APT or cyberattack threat to an instance. Such other response items, and combinations thereof, are intended for inclusion and pre-configuration in actionable logic module 400.

While the invention has been disclosed in connection with embodiments shown and described in detail, various modifications and improvements thereon will become readily apparent to those skilled in the art. Accordingly, the spirit and scope of the present invention is not to be limited by the foregoing examples but is to be understood in the broadest sense allowable by law.

This disclosure of the various embodiments of the invention, with accompanying drawings, is neither intended nor should it be construed as being representative of the full extent and scope of the present invention. The images in the drawings are simplified for illustrative purposes and are not necessarily depicted to scale. To facilitate understanding, identical reference terms are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

1. A data backup and recovery system for a virtual machine operative on a host machine in a cloud ecosystem, comprising:
a machine learning module;
an anomaly detection engine; and
an actionable logic module,
wherein, the machine learning module continuously accesses and reads a data recorded by a one or more system logs of the virtual machine to create and continuously update a baseline parameter of the data recorded by the system logs that is indicative of a typical, non-compromised operation of the virtual machine, and
wherein, the anomaly detection engine continuously monitors in real-time the data recorded by the system logs and compares said real-time data to the baseline parameter and determines whether said real-time data is a statistical anomaly with reference to the baseline parameter, and
wherein, if said real-time data represents a statistical anomaly with reference to the baseline parameter, the actionable logic module initiates a one or more response actions pre-configured from a set of pre-configurable actionable responses directed towards protecting a one or more existing data backups of the virtual machine.

2. The data backup and recovery system of claim 1, wherein:
the real-time data monitored by the anomaly detection engine comprises an online streaming data of the cloud ecosystem of the virtual machine.

3. The data backup and recovery system of claim 1, wherein:
the set of pre-configurable actionable responses is comprised of one or more of the following response actions:
catalogue the existing data backups;
catalogue a one or more existing replications of the existing data backups;
copy the existing data backups to a one or more data backup storage devices;
copy the existing replications to the data backup storage devices;
quarantine the virtual machine;
quarantine the existing data backups;
quarantine the existing replications;
quarantine the host machine;
issue an at least one alert to one or more users of the system;
perform a current backup of the virtual machine;
perform a current replication the existing data backup to the data backup storage devices;
restore the virtual machine from the existing data backups;
restore the virtual machine from the existing replications;
shutdown the virtual machine; and
shutdown the host machine.
